(19) United States
(12) Patent Application Publication
(10) Pub. No.: US 2014/0126328 A1
(43) Pub. Date: May 8, 2014

(54) Methods and Systems for Improving Microseismic Event Detection and Location

(71) Applicant: SCHLUMBERGER TECHNOLOGY CORPORATION, Sugar Land, TX (US)

(72) Inventors: Nobuyasu Hirabayashi, Kanagawa-ken (JP); Takanori Uchiyama, Machida-shi (JP); Alexander Savenko, Kanagawa-ken (JP)

(73) Assignee: Schlumberger Technology Corporation, Sugar Land, TX (US)

(21) Appl. No.: 13/669,452

(22) Filed: Nov. 6, 2012

(51) Int. Cl. G01V 1/28

(52) U.S. Cl. CPC G01V 1/282
USPC 367/73

(57) ABSTRACT

Methods and systems for location and/or direction of a hypocenter. The methods may involve one or more of: a) computing a joint probability density function (PDF) which includes polarization PDF and onset time PDF or a time integral of product of detection transforms to estimate the location and/or direction of a hypocenter, where the polarization PDF is generated using a weighted average of differences between measured and computed polarizations; b) computing a time integral of product of modified detection transforms associated with onset times from received data in Coalescence Microsesimic Mapping where modified detection transform is defined as (ε, fd(t)−1); c) resolving 180 degree ambiguities in polarization estimated according to Hodogram; d) using polynomial interpolation to tune the location of a hypocenter; and e) computing an integration time interval of 4-D (t,x,y,z) PDF or product of modified detection transform and the restriction on grid nodes.

### FIELD

The present disclosure relates to methods and systems for subterranean formation investigation and analysis. The present disclosure also relates to methods and systems for improving hypocenter event detection and location.

### BACKGROUND

Oil prices continue to rise in part because the demand for oil continues to grow, while stable sources of oil are becoming scarcer. Oil companies continue to develop new tools for generating data from boreholes with the hope of leveraging such data by converting it into meaningful information that may lead to improved production, reduced costs, and/or streamlined operations.

Logging tools are a major component of the wireline business and an increasing part of the logging-while-drilling business. While the logging tools provide measurements containing abundant indirect data about the subsurface, it remains a challenge to extract the geological and petrophysical knowledge contained therein, especially in a cost-effective and time-efficient manner.

Some of the data may relate to microseismic events, such as hydraulic fractures whether natural or man-made. Interpreting the data to determine the location and extent of hydraulic fractures, for example, is challenging in a downhole situation because sufficient coverage of the hypocenter is rarely obtained. In the face of this obstacle, polarization information obtained by downhole receivers has been used to locate the hypocenter. For example, to apply the inverse method using probability density function (Tarantola, A. and Valette, B, “Inverse Problems=Quest for Information,” J. Geophys. 50, 159-170, 1982), maximum likelihood method, Geiger and Coalescence Microseismic Mapping (“CMM”) (Drew et al., 2005, “Automated Microseismic Event Detection and Location by Continuous Mapping”: Proceedings of the Annual Technical Conference and Exhibition, SPE, 95513) to locate hypocenters with insufficient survey configurations, the polarizations of the P- and S- (Sh and/or Sv) waves are used to solve directional ambiguities. However, room for improving accuracy still exists due to the fact that the quality of estimated polarizations may vary significantly over receivers. Also, approaches to addressing the unreliability of polarization measurements, such as correlating linearity, may be affected by linear noise modes.

### SUMMARY

The present disclosure relates to methods and systems for analyzing raw data from downhole seismic array tools. The present disclosure more specifically relates to methods and systems for improving hypocenter detection and location, such as for microseismic events, earthquakes, and in monitoring reservoirs among other applications. In some embodiments, the present disclosure provides methods and systems for estimating a probable location or direction or both of a hypocenter from measured onset times and polarizations.

In some embodiments, the methods include measuring onset times and polarization data relating to a microseismic event using at least one downhole receiver; computing an onset time probability density function (“PDF”) from measured onset time data; computing a polarization PDF using a weighted average of differences between measured polarization data associated with the onset times and computed polarizations stored in a look-up table; computing a joint PDF from the polarization PDF and onset time PDF (for example from the polarization PDF and a 3-D (x,y,z) onset time PDF); and scanning the joint PDF to estimate a location or direction or both of a hypocenter. In some embodiments, data is received using at least two downhole receivers to resolve directional ambiguity caused by 180 degree polarization uncertainties. In other embodiments, where a-priori information can be used to resolve directional ambiguity, one downhole receiver may be used. In some embodiments, the look-up table saves travel times of P- and S- (Sh and/or Sv) waves, as well as polarization of P- and S- (Sh and/or Sv) waves and can be a 3-D grid generated using at least one forward modeling tool such as Ray tracing, Eikonal equation, Finite Difference and Element methods among others. In some embodiments, a look-up table is generated for each receiver in a receiver array for which polarization and travel time data is collected for a given event.

In further embodiments, an inverse method using a probability density function, such as Tarantola's method, is applied to compute the onset time PDF.

In other embodiments, Coalescence Microseismic Mapping (“CMM”) using a modified detection transform is applied to compute an onset time PDF. In further embodiments, the modified detection transform is a time integral of a product of detection transforms associated with the measured onset times. In other embodiments, the modified detection transform is defined as f_{d}′(t)=(ε, f_{d}(t)−1) where f_{d}(t) is the detection transform, and ε is a small, positive number. In some embodiments, the detection transform is defined by the ratio of root mean squares (“RMS”) of following short and preceding long time windows of signals according to:

$${f}_{d} ( t ) = \frac{\sqrt{\frac{1}{S} {\int }_{0}^{S} {A}^{2} ( t + τ ) d τ}}{\sqrt{\frac{1}{L} {\int }_{0}^{L} {A}^{2} ( t - τ ) d τ}}$$

where A(t) is the envelope of three component waveforms, S and L are the lengths of following short and preceding long time windows whose lengths are decided depending on the dominant frequency of event signals (for example, a half period of event signal may be used for the length of following short window and 5 to 10 times length of following short window may be used for the length of preceding long window). The numerator and denominator of the detection transform are the RMS of following short time window and preceding long window respectively. In some embodiments, ε is exp(−2).

In some embodiments, the methods include receiving polarization information relating to an event such as a microseismic event or an earthquake using at least one downhole receiver or at least two downhole receivers, as appropriate; and computing the reference direction of polarization that is used to decide the sign of measured polarization through inner product according to:

$${v}_{Ref} = {\sum }_{j \neq k} {c}_{2} Weight ( \frac{{p}^{j} + {c}_{1} {p}^{k}}{\vert {p}^{j} + {c}_{1} {p}^{k} \vert} )$$

where c₁=sgn(p^{j}·p^{k}),
c₂=−sgn((xₗ^{j}−xₗ^{k})(pₗ^{j}−pₗ^{k})),
l is the index which provides the maximum |xₗ^{j}−xₗ^{k}|,

$$Weight = \sqrt{max ( {SNR}_{j} - 1 , 0 ) max ( {SNR}_{k} - 1 , 0 ) {Linearity}_{j}^{q} {Linearity}_{k}^{q}}$$

where SNR is the value of detection transform at onset time,
q is a power to be selected, and
the i-th receiver's position and polarization vector are denoted by
xⁱ=(x₁ⁱ,x₂ⁱ,x₃ⁱ) and pⁱ=(p₁ⁱ,p₂ⁱ,p₃ⁱ),
where the sign of polarization vector is given by sgn(pⁱ·v_{Ref}).

In some embodiments, the methods include receiving data relating to an event such as a microseismic event or an earthquake using at least one downhole receiver, or at least two downhole receivers, as appropriate; using the data to compute a joint PDF of hypocenter location; normalizing PDF according to f(x, y, z)=F⁻ⁿ(x, y, z) where n is the number of data used; and tuning an event location according to:

$$δ x = \frac{{u}_{-} - {u}_{+}}{4 a Δ x} , a = \frac{{u}_{+} - 2 {u}_{0} + {u}_{-}}{2 Δ {x}^{2}}$$

where the tuned location is given by x₀+δx, and
x₋, x₀ and x₊ are grid nodes spaced by Δx,
a location function u₀=f(x₀,y₀,z₀) is bigger than u₋=f(x₋,y,z) and u₊=f(x₊,y,z),
y and z are scanned in ranges such that |y₀−y|<pΔy and |z₀−z|<qΔz, and
points which have maximum values are selected.

In some embodiments, the time interval of integration of 4-D (t,x,y,z) PDF in an inverse method or the product of detection transforms in CMM and the restriction of grid nodes are computed for a hypocenter assumed to be located at the grid node of (x, y, z) as follows:

The start time can be computed as

$${T}_{Start} ( x , y , z ) = \frac{1}{N} {\sum }_{i = 1}^{N} ( {T}_{i} - {t}_{i} ( x , y , z ) )$$

where i is the index of data that indicates the receiver and component of signal (e.g., P- or S- (Sh and/or Sv) waves), T_{Start}(x,y,z) is the start time for (x,y,z); Tᵢ is the onset time; tᵢ(x,y,z) is the travel time between (x,y,z) to the receiver, and N is the number of data. If the uncertainties of onset times are known, the equation can be replaced by

$${T}_{Start} ( x , y , z ) = {\sum }_{i = 1}^{N} \frac{1}{{σ}_{i}^{2}} ( {T}_{i} - {t}_{i} ( x , y , z ) ) / {\sum }_{i = 1}^{N} \frac{1}{{σ}_{i}^{2}}$$

where σᵢ is the uncertainty of onset time of the i-th data. In the CMM case, σᵢ is taken as the length of following short time window of detection transform. The integration interval for (x, y, z,) is taken as:

|T_{Start}(x,y,z)−t|≦Cσᵢ

where t is the time and C is a parameter which is specifically taken to be from 2 to 4. The time integration and grid search is restricted for the grid nodes which satisfy

|T_{Start}(x,y,z)+tᵢ(x,y,z)−Tᵢ|≦Cσᵢ

for all i.

In some embodiments, the systems include at least one downhole receiver for recording time and polarization information relating to a seismic event (such as an earthquake or a microseismic event), and an electronics subsystem for at least one of:
A) comparing the recorded polarization for a picked onset time with a computed polarization stored in a look-up table to generate a difference in recorded and computed polarization for each receiver; computing a polarization PDF using a weighted average of polarization difference whose weights are properties of signals (e.g., SNR and linearity); and computing a joint PDF which includes polarization PDF and onset time PDF or the time integral of product of detection transforms to estimate the location, direction, or both of the event hypocenter;
B) computing the reference direction of polarization that is used to decide the sign of measured polarization vectors through inner product according to:

$${v}_{Ref} = {\sum }_{j \neq k} {c}_{2} Weight ( \frac{{p}^{j} + {c}_{1} {p}^{k}}{\vert {p}^{j} + {c}_{1} {p}^{k} \vert} )$$

where c₁=sgn(p^{j}·p^{k}),
c₂=−sgn((xₗ^{j}−xₗ^{k})(pₗ^{j}−pₗ^{k})),
l is the index which provides the maximum |xₗ^{j}−xₗ^{k}|,

$$Weight = \sqrt{max ( {SNR}_{j} - 1 , 0 ) max ( {SNR}_{k} - 1 , 0 ) {Linearity}_{j}^{q} {Linearity}_{k}^{q}}$$

where SNR is the value of detection transform at onset time,
q is a power to be selected, and
the i-th receiver's position and polarization vector are denoted by x^{j}32 (x₁ⁱ,x₂ⁱ,x₃ⁱ) and pⁱ=(p₁ⁱ,p₂ⁱ,p₃ⁱ),
where the sign of polarization vector is given by sgn(pⁱ·v_{Ref}).
C) computing a PDF of hypocenter location; normalizing the PDF according to f(x, y, z)=F⁻ⁿ(x, y, z) where n is the number of data used; and, tuning an event location according to:

$$δ x = \frac{{u}_{-} - {u}_{+}}{4 a Δ x} , a = \frac{{u}_{+} - 2 {u}_{0} + {u}_{-}}{2 Δ {x}^{2}}$$

wherein the tuned location is given by x₀+δx, and
x₋, x₀ and x₊ are grid nodes spaced by Δx,
a location function u₀=f (x₀, y₀, z₀) is bigger than u₋=f(x₋,y,z) and u₊=f(x₊,y,z),
y and z are scanned in ranges such that |y₀−y<<pΔy and |z₀−z<qΔz, and points which have maximum values are selected.
and,
D) computing the integration interval of time for 4-D (t,x,y,z) PDF, and the restriction on grid nodes for a hypocenter located at the grid node of (x, y, z) according to:

$${T}_{Start} ( x , y , z ) = \frac{1}{N} {\sum }_{i = 1}^{N} ( {T}_{i} - {t}_{i} ( x , y , z ) )$$

where i is the index of data that indicates the receiver and component of signal (e.g., P- or S- (Sh and/or Sv) waves), T_{Start}(x,y,z) is the start time for (x,y,z); Tᵢ is the onset time;
tᵢ(x,y,z) is the travel time between (x, y, z) and the receiver, and N is the number of data;
further wherein if the uncertainties of onset times are known, the equation can be replaced by

$${T}_{Start} ( x , y , z ) = {\sum }_{i = 1}^{N} \frac{1}{{σ}_{i}^{2}} ( {T}_{i} - {t}_{i} ( x , y , z ) ) / {\sum }_{i = 1}^{N} \frac{1}{{σ}_{i}^{2}}$$

where σᵢ is the uncertainty of onset time of the i-th data. In CMM case, σᵢ is taken as the length of following short time window of detection transform;
further wherein the integration interval for (x, y, z) is taken as

|T_{Start}(x,y,z)−t|≦Cσᵢ

where t is the time and C is a parameter which ranges from 2 to 4 and the time integration and grid search is restricted for the grid nodes which satisfy

|T_{Start}(x,y,z)+tᵢ(x,y,z)−Tᵢ|≦Cσᵢ

for all i.

The identified embodiments are exemplary only and are therefore non-limiting. The details of one or more non-limiting embodiments of the present disclosure are set forth in the accompanying drawings and the descriptions below. Other embodiments should be apparent to those of ordinary skill in the art after consideration of the present disclosure.

### BRIEF DESCRIPTION OF DRAWINGS

FIG. 1 is a partial schematic representation of an exemplary apparatus for logging while drilling that is compatible with the systems and methods of this disclosure.

FIG. 2 is a partial schematic representation of another exemplary apparatus that is compatible with the systems and methods of this disclosure.

FIGS. 3A-3D are schematic illustrations of an embodiment of a seismic tool compatible with systems and methods of this disclosure.

FIG. 4 is a flow diagram illustrating a relationship between methods according to this disclosure and CMM.

FIG. 5 are comparative graphs providing an example of results generated using an embodiment of a method according to this disclosure.

FIG. 6 shows downhole receivers and hypocenter locations used in a synthetic test. 12 receivers are installed in a vertical well and hypocenters are in three circles of 500, 1000 and 1500 ft away from the well.

FIG. 7 shows an example of synthetic waveforms for the 12 receivers of FIG. 6.

FIG. 8 shows the hypocenters located using an embodiment of direction estimation methods according to this disclosure. The hypocenters are located close to the exact positions and mostly they are overlaid.

FIG. 9 shows the located hypocenters of FIG. 8 viewed from above, and illustrates that the hypocenters are correctly distributed over 360 degrees without leaving 180 degree directional ambiguities.

### DETAILED DESCRIPTION

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrases “for example,” “such as,” “including” and the like are used herein, the phrase “and without limitation” is understood to follow unless explicitly stated otherwise.

The terms “comprising” and “including” and “involving” (and similarly “comprises” and “includes” and “involves”) are used interchangeably and mean comprising. Specifically, each of the terms is defined consistent with the common United States patent law definition of “comprising” and is therefore interpreted to be an open term meaning “at least the following” and also interpreted not to exclude additional features, limitations, aspects, etc.

The term “about” is meant to account for variations due to experimental error. The term “substantially” is meant to permit deviations from a descriptor that does not negatively impact the intended purpose. All measurements or numbers are implicitly understood to be modified by the word about, even if the measurement or number is not explicitly modified by the word about. Similarly, descriptive terms are implicitly understood to be modified by the word substantially, even if the term is not explicitly modified by the word substantially.

“Measurement While Drilling” (“MWD”) can refer to devices for measuring downhole conditions including the movement and location of the drilling assembly contemporaneously with the drilling of the well. “Logging While Drilling” (“LWD”) can refer to devices concentrating more on the measurement of formation parameters. While distinctions may exist between these terms, they are also often used interchangeably. For purposes of this disclosure MWD and LWD are used interchangeably and have the same meaning. That is, both terms are understood as related to the collection of downhole information generally, to include, for example, both the collection of information relating to the movement and position of the drilling assembly and the collection of formation parameters.

Whenever the phrase “derived from” or “calculated from” or the like are used, “directly or indirectly” are understood to follow. Also, the phrases “estimating from the data” or “calculating from the data” or the like are understood to mean “from the data or subset of the data.”

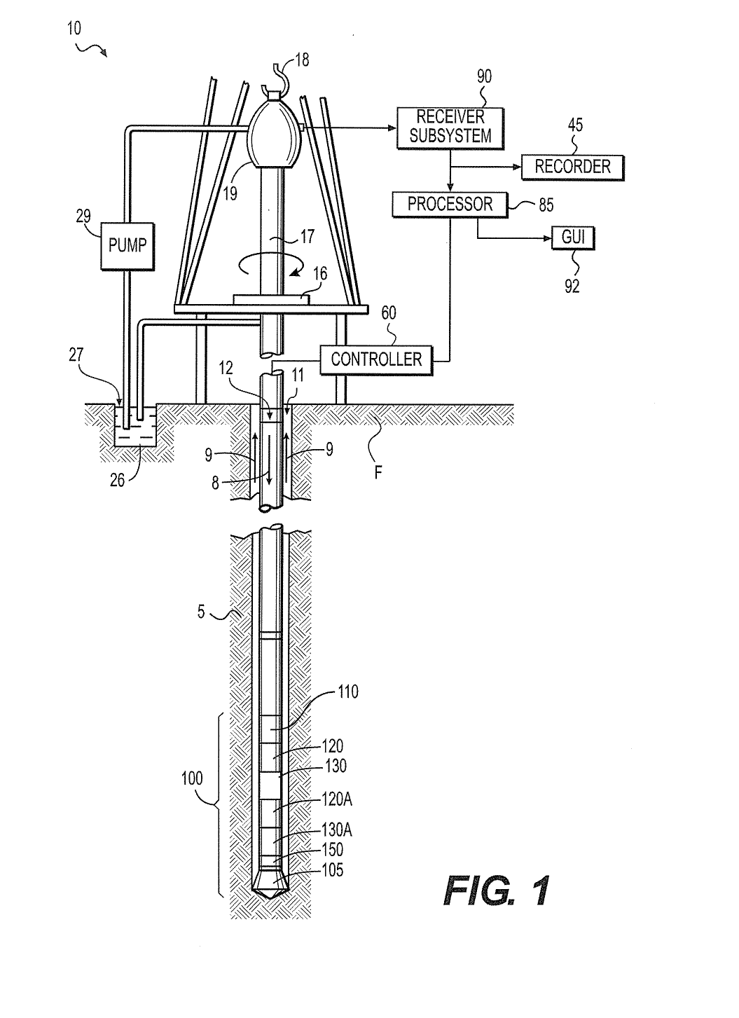

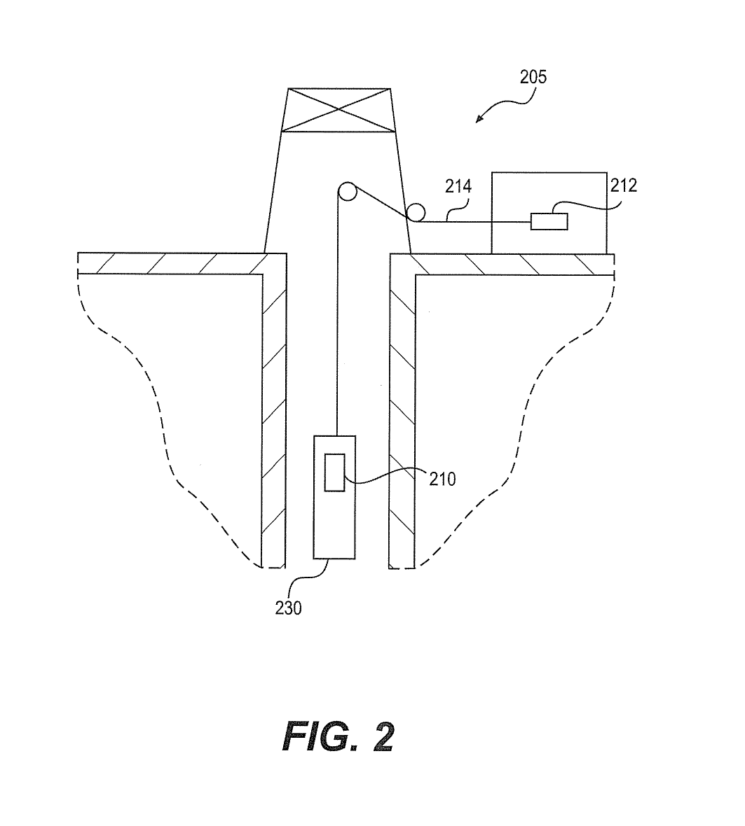

FIGS. 1 and 2 illustrate non-limiting, exemplary well logging systems used to obtain well logging data and other information, which may be used with systems and methods in accordance with embodiments of the present disclosure.

FIG. 1 illustrates a land-based platform and derrick assembly (drilling rig) 10 and drill string 12 with a well logging data acquisition and logging system, positioned over a wellbore 11 for exploring a formation F. In the illustrated embodiment, the wellbore 11 is formed by rotary drilling in a manner that is known in the art. Those of ordinary skill in the art given the benefit of this disclosure will appreciate, however, that the subject matter of this disclosure also finds application in directional drilling applications as well as rotary drilling, and is not limited to land-based rigs. In addition, although a logging while drilling apparatus is illustrated, the subject matter of this disclosure is also applicable to wireline operations (for example as shown in FIG. 2).

A drill string 12 is suspended within the wellbore 11 and includes a drill bit 105 at its lower end. The drill string 12 is rotated by a rotary table 16, energized by means not shown, which engages a kelly 17 at the upper end of the drill string. The drill string 12 is suspended from a hook 18, attached to a travelling block (also not shown), through the kelly 17 and a rotary swivel 19 which permits rotation of the drill string 12 relative to the hook 18.

Drilling fluid or mud 26 is stored in a pit 27 formed at the well site. A pump 29 delivers the drilling fluid 26 to the interior of the drill string 12 via a port in the swivel 19, inducing the drilling fluid to flow downwardly through the drill string 12 as indicated by the directional arrow 8. The drilling fluid exits the drill string 12 via ports in the drill bit 105, and then circulates upwardly through the region between the outside of the drill string 12 and the wall of the wellbore, called the annulus, as indicated by the direction arrows 9. In this manner, the drilling fluid lubricates the drill bit 105 and carries formation cuttings up to the surface as it is returned to the pit 27 for recirculation.

The drill string 12 further includes a bottomhole assembly (“BHA”), generally referred to as 100, near the drill bit 105 (for example, within several drill collar lengths from the drill bit). The BHA 100 includes capabilities for measuring, processing, and storing information, as well as communicating with the surface. The BHA 100 thus may include, among other things, one or more logging-while-drilling (“LWD”) modules 120, 120A and/or one or more measuring-while-drilling (“MWD”) modules 130, 130A. The BHA 100 may also include a roto-steerable system and motor 150.

The LWD and/or MWD modules 120, 120A, 130, 130A can be housed in a drill collar, as is known in the art, and can contain one or more types of logging tools for investigating well drilling conditions or formation properties. The logging tools may provide capabilities for measuring, processing, and storing information, as well as for communication with surface equipment.

The BHA 100 may also include a surface/local communications subassembly 110, which may be configured to enable communication between the tools in the LWD and/or MWD modules 120, 120A, 130, 130A and processors at the earth's surface. For example, the subassembly 110 may include a telemetry system that includes an acoustic transmitter that generates an acoustic signal in the drilling fluid (a.k.a. “mud pulse”) that is representative of measured downhole parameters. The acoustic signal is received at the surface by instrumentation that can convert the acoustic signals into electronic signals. For example, the generated acoustic signal may be received at the surface by transducers. The output of the transducers may be coupled to an uphole receiving system 90, which can demodulate the transmitted signals. The output of the receiving system 90 may be coupled to a computer processor 85 and a recorder 45. The computer processor 85 may be coupled to a monitor, which employs graphical user interface (“GUI”) 92 through which the measured downhole parameters and particular results derived therefrom are graphically or otherwise presented to the user. In some embodiments, the data is acquired real-time and communicated to the back-end portion of the data acquisition and logging system. In some embodiments, the well logging data may be acquired and recorded in the memory in downhole tools for later retrieval.

The LWD and MWD modules 120, 120A, 130, 130A may also include an apparatus for generating electrical power to the downhole system. Such an electrical generator may include, for example, a mud turbine generator powered by the flow of the drilling fluid, but other power and/or battery systems may be employed additionally or alternatively.

The well-site system is also shown to include an electronics subsystem comprising a controller 60 and a processor 85, which may optionally be the same processor used for analyzing logging tool data and which together with the controller 60 can serve multiple functions. For example, the controller 60 and processor 85 may be used to power and operate the logging tools. The controller and processor need not be on the surface as shown but may be configured in any way known in the art. For example, alternatively, or in addition, the controller and/or processor may be part of the MWD (or LWD) modules or may be on-board the tool itself.

In the methods and systems according to this disclosure, the electronics subsystem (whether located on the surface or sub-surface on or within the tool or some combination thereof) includes machine-readable instructions for performing one or more of the calculations, analytics and evaluations disclosed herein.

FIG. 2 illustrates a wireline logging system 205 suitable for use with the systems and methods of this disclosure. As shown in FIG. 2, a transmitter 210 receives the acquired well logging data from a sensor included in the wireline tool 230. The transmitter 210 may communicate the acquired well logging data to a surface processer 212 via a logging cable 214. The logging cable 214 is commonly referred to as a wireline cable. In some embodiments, the processor 212 or a back-end portion (not shown) of the wireline logging system may include a computer system to process the acquired well logging data.

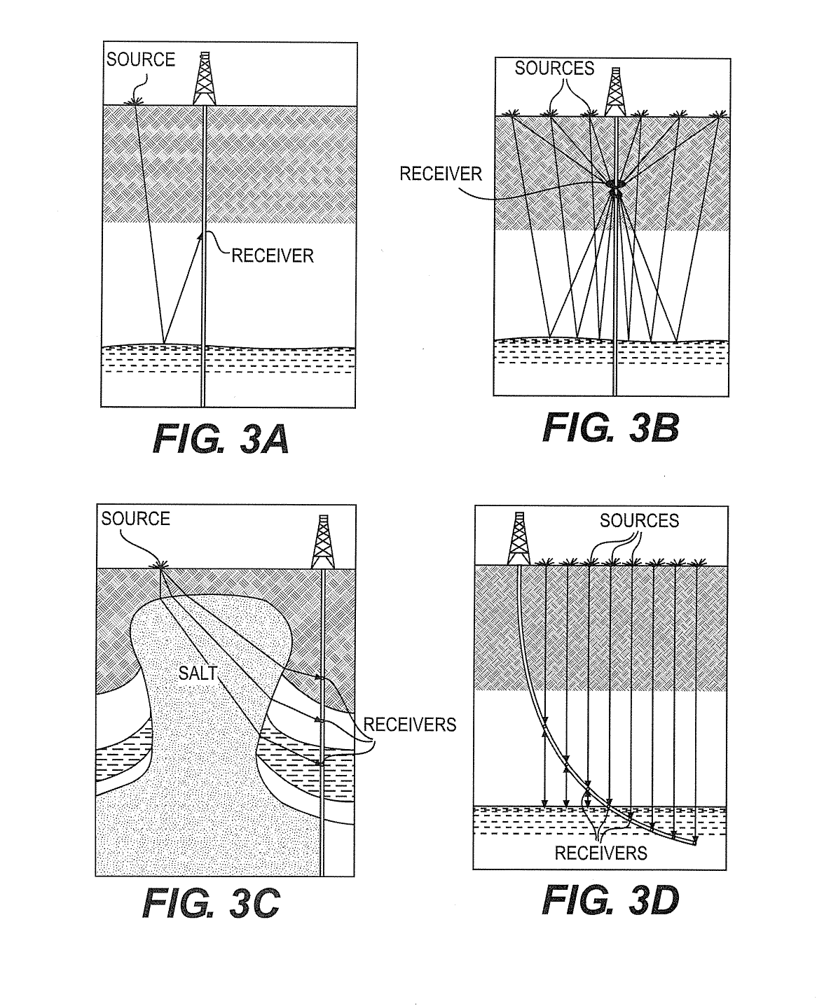

FIG. 3 illustrates a seismic-while-drilling tool which can be the LWD tool 120, or can be part of an LWD tool suite 120A of the type disclosed in P. Breton et al., “Well Positioned Seismic Measurements,” Oilfield Review, pp. 32-45, Spring, 2002. The downhole LWD tool can have a single receiver (as depicted in FIGS. 3A and 3B), or plural receivers (as depicted in FIGS. 3C and 3D). Embodiments for detecting, location, or estimating the direction of a hypocenter according to the present disclosure may utilize one or more receivers, for example two or more, three or more, four or more, five or more, six or more, seven or more, or eight or more receivers. The receivers may record time and polarization (e.g. azimuth and dip) information relating to a seismic event (such as a microseismic event or an earthquake), when an event occurs.

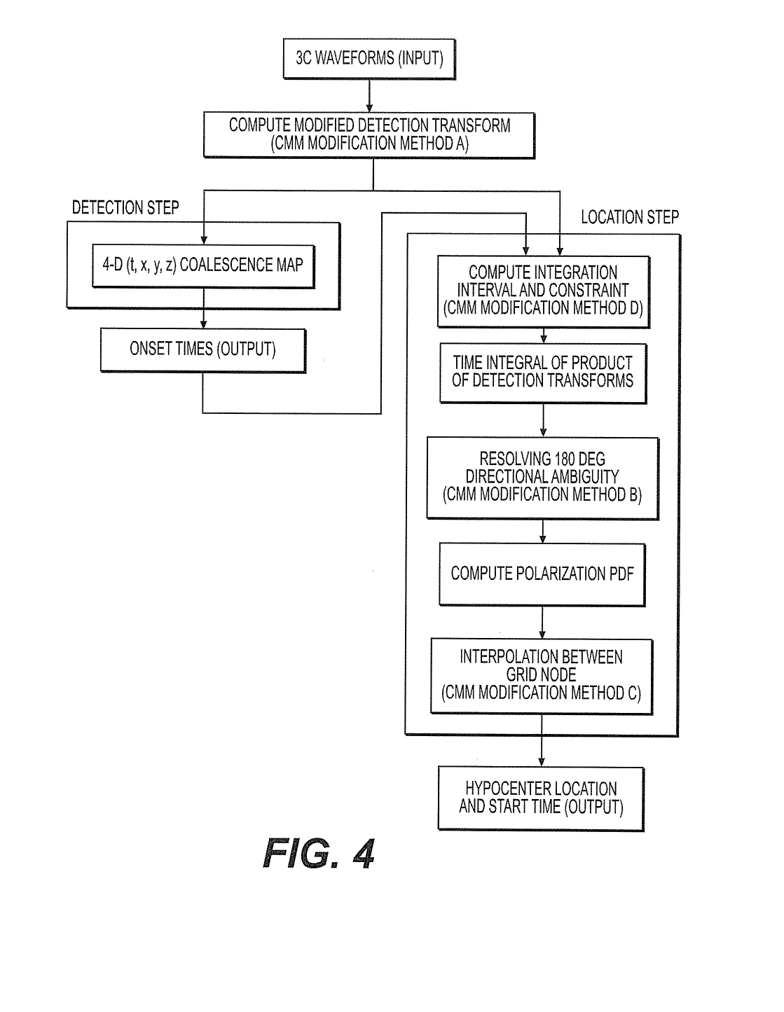

Embodiments according to the present disclosure relates to methods and systems for analyzing raw data from downhole seismic array tools, for example as discussed in reference to FIGS. 1-3. In some embodiments, the present disclosure provides methods and systems for improving hypocenter detection and location, for example methods and systems for improving hypocenter detection and location as compared to CMM. FIG. 4 is a flow diagram which illustrates how methods according to this disclosure may improve detection and location accuracy in various steps of CMM. “Compute polarization PDF” in the flow diagram corresponds to the section entitled “Polarization probability density function methods” below. Method A, Method B, Method C, and Method D in the flow diagram correspond to the subsections A, B, C, and D of the section entitled “CMM Modification Methods” below.

Polarization probability density function methods. In general, maximum likelihood methods including cost function methods for improving location and/or detection of a hypocenter involve initially implementing any method suitable for locating a hypocenter using only onset times, in order to first obtain the 3-D (x,y,z) PDF in Tarantola's method or the time integral of detection transforms in CMM. As the time integral of the product of detection transforms used in CMM can be regarded as a particular case of Tarantola's method, this integral is also referred to as a PDF and both PDFs are commonly denoted by PDF_{Time}(x, y, z).

When an event occurs, receivers in the seismic array tools may gather information relating to polarization and onset time. According to methods of the present disclosure, the polarization at a receiver associated with a picked onset time is compared to polarizations stored in a look-up table. The tables of travel times and polarizations at receivers (look-up table) are prepared for all possible hypocenter locations as grids. The travel times and polarizations are computed using ray tracing, Eikonal equation or finite difference method, or any other suitable method. Then, the polarization PDF denoted by PDF_{Pol}(x, y, z) is computed using the weighted average of differences between the measured and computed polarizations for all receivers (or a subset of receivers, according to the users' preference) and the joint PDF:

PDF(x, y, z)=PDF_{Time}(x, y, z)×PDF_{Pol}(x, y, z)

is computed to obtain a unique hypocenter location.

In general, the greater the number of receivers, the greater the accuracy of the result. However, the number of receivers may be constrained by field conditions or other factors. The number of receivers may also relate to a given tool's performance. In some embodiments, the number of receivers is 1. In some embodiments, the number of receivers is 2 or 3 or 4 or 5 or 6 or 7. In some embodiments, the number of receivers is 8. In some embodiments, the number of receivers is 8 or more. By scanning the joint PDF by the grid search, the most probable location or direction of hypocenter can be determined.

More specifically, in the first step, where only onset times are used, the inverse method using probability density function (Tarantola and Valette, 1982) or CMM (Drew et al, 2005) is applied to obtain the 3-D (x,y,z) PDF of the hypocenter location. Because the hypocenter location is computed only using the onset times with insufficient survey configurations, there may be directional ambiguities of hypocenter location. Regarding the signal components to be used in the computation of direction of hypocenter location, both of the P- and S- (Sh and/or Sv) waves, only the P-waves, or only the S-waves may be specified by the users.

The look-up table, which stores the travel-times from hypocenters to a receiver and the polarization vectors at a receiver, is created in a volume where hypocenter locations are anticipated. The look-up table is created using ray tracing, Eikonal equation or finite difference method or any other suitable method.

The difference or error of polarization vectors is defined by:

θ_{i,Error}(x,y,z)=|A cos(P_{i,mes}·P_{i,comp}(x,y,z))|

where i is the index of a receiver, θ_{i,Error} is the polarization error, and P_{i,mes} and P_{i,comp}(x,y,z) are the measured and computed polarization vectors at the i-th receiver for the hypocenter location at (x,y,z) respectively.

All vectors used here are normalized. The hypocenter location or most probable direction of hypocenter is solved by minimizing the weighted average defined by:

$${θ}_{Error} ( x , y , z ) = {( \frac{{\sum }_{i = 1}^{N} {w}_{i} {θ}_{i , Error}^{n} ( x , y , z )}{{\sum }_{i = 1}^{N} {w}_{i}} )}^{- n}$$

where n is an appropriate power to be selected and wᵢ is a weight function of Signal-to-Noise Ratio (“SNR”), linearity and orthogonality of event signal denoted by:

wᵢ=f(SNRᵢ,Linearityᵢ,Orthogonalityᵢ)

where SNR is the value of the detection transform at the onset time.

In some embodiments, the weight function may be simplified as:

wᵢ=SNRᵢ^{p}·Linearityᵢ^{q}·Orthogonalityᵢ^{r}

where p, q and r are appropriate powers to be selected. In some embodiments, n, p, q, and r are 1. In some embodiments, n, p, q, and/or r are tuned as may be appropriate for the acquisition data, tool's performance, local geography or other characteristics. A person of skill reading this disclosure will understand what an appropriate n, p, q, r may be, and whether or not, and how to tune the choice of these parameters.

SNR (Signal-to-Noise Ratio) in the above equation may be replaced by:

SNR′=max(SNR−1,0)

By denoting (x′, y′, z′) that minimizes θ_{Error}(x, y, z), the polarization PDF to be applied in the method using the weighted average of polarization differences can be defined by:

$${PDF}_{Pol} ( x , y , z ) = {\prod }_{i} exp [ - \frac{1}{2} {( \frac{{θ}_{i , Error} ( x , y , z ) - {θ}_{i , Error} ( {x}^{′} , {y}^{′} , {z}^{′} )}{{σ}_{i}} )}^{2} ]$$

where σⁱ=max(θ_{i,Error}(x′,y′,z′),θₘᵢₙ) and θₘᵢₙ is the minimum angle defined by the users.

By defining a standard deviation by:

$${σ}_{θ} = {( \frac{1}{N} {\sum }_{i} {σ}_{i}^{- 2} )}^{- 2}$$

in the vicinity of (x′,y′,z′),

$${\vert \frac{{θ}_{Error} ( x , y , z ) - {θ}_{Error} ( {x}^{′} , {y}^{′} , {z}^{′} )}{{σ}_{θ}} \vert}^{2} \approx \frac{1}{N} {\sum }_{i} {( \frac{{θ}_{i , Error} ( x , y , z ) - {θ}_{i , Error} ( {x}^{′} , {y}^{′} , {z}^{′} )}{{σ}_{i}} )}^{2}$$

is anticipated for rather good quality data, therefore the polarization PDF may be defined by

$${PDF}_{Pol} ( x , y , z ) = exp [ - \frac{1}{2} {( \frac{{θ}_{Error} ( x , y , z ) - {θ}_{Error} ( {x}^{′} , {y}^{′} , {z}^{′} )}{{σ}_{θ}} )}^{2} ] .$$

In some embodiments, the polarization PDF may be simplified as:

$${PDF}_{Pol} ( x , y , z ) = exp [ - \frac{1}{2} {( \frac{{θ}_{Error} ( x , y , z )}{{σ}_{θ}} )}^{2} ] .$$

By choosing appropriate n, a robust estimation for poor quality data, such as low SNR and low linearity, may be stably made using the above equation.

An example of the polarization probability density function methods for detecting and/or locating an event is as follows:
Polarization PDF for a grid point (x, y, z) is computed by

$${PDF}_{Pol} ( x , y , z ) = exp [ - \frac{1}{2} \frac{δ {\overline{θ}}^{2} ( x , y , z )}{{\overline{σ}}_{θ}^{2}} ] exp [ - \frac{1}{2} \frac{δ {\overline{ϕ}}^{2} ( x , y , z )}{{\overline{σ}}_{ϕ}^{2}} ] , \\ δ \overline{θ} ( x , y , z ) = {( \frac{\sum {w}_{i} δ {θ}_{i}^{n} ( x , y , z )}{\sum {w}_{i}} )}^{- n} , \\ δ \overline{ϕ} ( x , y , z ) = {( \frac{\sum {w}_{i} δ {ϕ}_{i}^{n} ( x , y , z )}{\sum {w}_{i}} )}^{- n} , \\ {\overline{σ}}_{θ}^{2} = {( {\sum }_{i} \frac{1}{δ {θ}_{i}^{2} ( {x}^{′} , {y}^{′} , {z}^{′} )} )}^{- 1} , {\overline{σ}}_{ϕ}^{2} = {( {\sum }_{i} \frac{1}{δ {ϕ}_{i}^{2} ( {x}^{″} , {y}^{″} , {z}^{″} )} )}^{- 1}$$

where
wᵢ: Weight function
δθᵢ(x,y,z), δφᵢ(x,y,z): Azimuth and inclination errors at (x,y,z)
(x′,y′,z′), (x″,y″,z″): Points such that

$$δ \overline{θ} ( {x}^{′} , {y}^{′} , {z}^{′} ) = {min}_{x , y , z} [ δ \overline{θ} ( x , y , z ) ] , δ \overline{ϕ} ( {x}^{″} , {y}^{″} , {z}^{″} ) = {min}_{x , y , z} [ δ \overline{ϕ} ( x , y , z ) ] .$$

In some embodiments, θ_{Error}(x,y,z) is computed using the trimmed mean. By indexing θ_{i,Error} (x,y,z) in the ascending order, θ_{j,Error}′(x,y,z) can be defined. By specifying the appropriate number M (M<N), the trimmed average is computed as:

$${θ}_{Error} ( x , y , z ) = \frac{1}{M} {\sum }_{j = 1}^{M} {θ}_{j , Error}^{′} ( x , y , z ) .$$

In general, M is chosen to be a half of N. The following computations are same as above.

With respect to polarization probability density function methods, linearity may be defined by:

$$Linearity = 2 ( \frac{{σ}_{1}}{{σ}_{1} + {σ}_{2}} - \frac{1}{2} )$$

or:

$$Linearity = \sqrt{\frac{{σ}_{1}}{{σ}_{1} + {σ}_{2} + {σ}_{3} }}$$

where θ₁, θ₂, θ₃ are eigenvalues of a cross-correlation matrix of three component signals for Hodogram that satisfy σ₁≧σ₂≧σ₃. Furthermore, orthogonality may defined by:

Orthogonality=\sqrt{1−P_{P}·P_{SH}}

where P₁, and P_{SH} are polarization vectors of P- and S- (Sh and/or Sv) waves respectively.

CMM Modification Methods
A) Modification of detection transform. In general, this method of improving detection and/or location of a hypocenter, where the computation of the time integral of the product of detection transforms over receivers associated with onset times is utilized, involves the use of the detection transform in CMM, instead of Gaussian functions which are used in Tarantola's method (Tarantola and Valette, 1982). The detection transform (Drew et al., 2005) is defined by the ratio of root mean squares of following short and preceding long time windows of signals as

$${f}_{d} ( t ) = \frac{\sqrt{\frac{1}{S} {\int }_{0}^{S} {A}^{2} ( t + τ ) d τ}}{\sqrt{\frac{1}{L} {\int }_{0}^{L} {A}^{2} ( t - τ ) d τ}}$$

where A(t) is the envelope of three component waveforms, S and L are the lengths of following short and preceding long time windows whose lengths are decided depending on the dominant frequency of event signals (typically a half period of event signal is used for the length of following short window and 5 to 10 times length of following short window is used for the length of preceding long window). The numerator and denominator of detection transform are RMS of the following short time window and preceding long window respectively.

The product of detection transforms and its time integral are defined as

$$g ( t \text{:} x , y , z ) = {\prod }_{i} {f}_{d , i} ( t + {t}_{i} ( x , y , z ) ) {h}_{i} ( t + {t}_{i} ( x , y , z ) )$$

$$and$$

$$G ( x , y , z ) = {\int }_{{T}_{Start} - T / 2}^{{T}_{Start} + T / 2} g ( τ \text{:} x , y , z ) d τ$$

where i is the index that indicates the receiver and component of signal (e.g., P- and S- (Sh and/or Sv) waves), f_{d,i}(t) is the detection transform, t is time, tᵢ(x, y, z) is the travel time for (x, y, z) grid node, hᵢ(t) is an optional function such as orthogonality when the users want to reduce the number of wrong detections caused by picking only P-waves or only S-waves where the detection of both P- and Sh-waves are specified (Drew et al., 2005), T_{Start} and T are the start time and the interval of time integral respectively. The summation is usually taken in a certain time interval centered by a detected start time.

There are two challenges which may result in inaccuracies in the computation of the product of detection transforms for the direct use of detection transform. One is the bias of detection transform. Generally, the detection transform is one for the time there is no signal, but this may result in aliasing because the detection transform of an event signal may not be sufficiently larger than one. The other challenge is asymmetry of the shape of the detection transform. The detection transform may be asymmetrical before and after the onset time, which may cause a shift in an event location.

According to the instant methods, detection transform is redefined as:

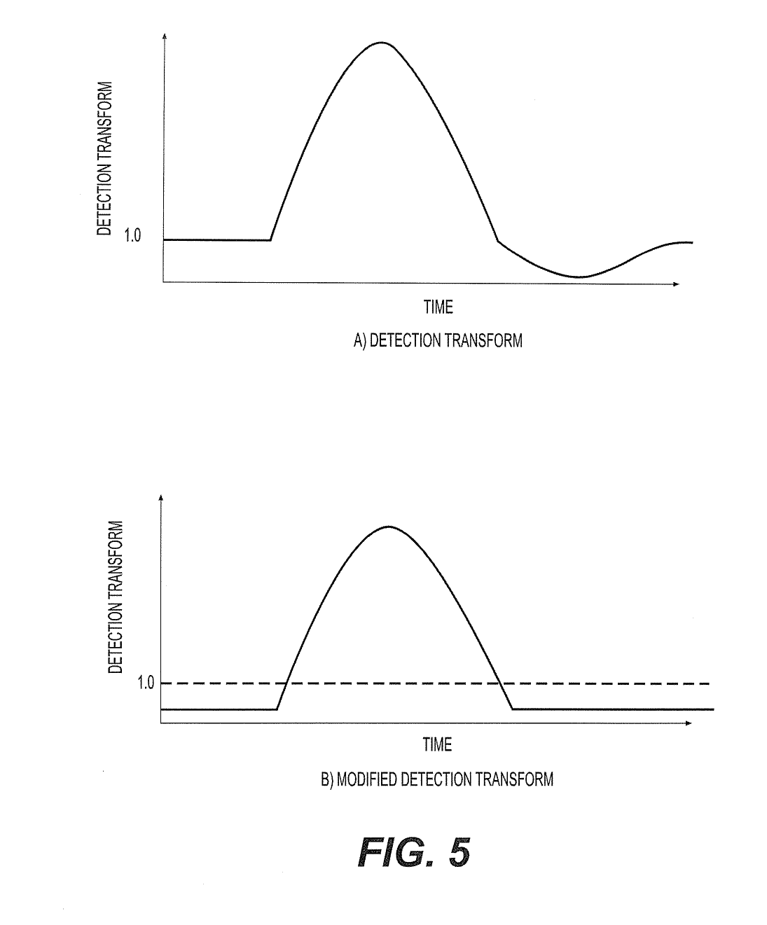

f_{d}′(t)=max(ε,f_{d}(t)−1)

where ε is a positive small number chosen to avoid losing events when event signals are not recorded in some traces. An example, where ε=exp(−2), is illustrated in FIG. 5.
B) Resolving 180 degree directional ambiguities. In some embodiments, methods of improving the detection and/or location of a hypocenter involve resolving 180 degree directional ambiguities in the polarization estimated using Hodogram. The directional ambiguities of event location may be solved using a reference vector computed using the inclinations of P-waves measured by receivers.

In some embodiments, the reference vector is computed and an inner product is taken with the polarization vector from measurement. An example of this approach is provided below:
Denote i-th receiver's position and polarization vecotor by xⁱ=(x₁ⁱ,x₂ⁱx₃ⁱ) and pⁱ=(p₁ⁱ,p₂ⁱ,p₃ⁱ),
the sign of polarization vector is given by sgn(pⁱ·v_{Ref}).
The reference vector for polarization vectors is computed by

$${v}_{Ref} = {\sum }_{j \neq k} {c}_{2} Weight ( \frac{{p}^{j} + {c}_{1} {p}^{k}}{\vert {p}^{j} + {c}_{1} {p}^{k} \vert} )$$

where c₁=sgn(p^{j}·p^{k}),
c₂=−sgn((xₗ^{j}−xₗ^{k})(pₗ^{j}−pₗ^{k})),
l is the index which provides the maximum |xₗ^{j}−xₗ^{k}|,

$$Weight = \sqrt{max ( {SNR}_{j} - 1 , 0 ) max ( {SNR}_{k} - 1 , 0 ) {Linearity}_{j}^{q} {Linearity}_{k}^{q}}$$

where q is a power to be selected.
C) Interpolation methods of event location between grid nodes. In some embodiments, methods of improving the detection and/or location of a hypocenter involve an interpolation method for locating an event in between nodes of a grid. Rather than using Gaussian fitting, polynomial interpolation is used to tune the location of the hypocenter as follows:
Integral of product of detection transforms which is multiplied by the joint polarization PDF is normalized as

f(x,y,z)=F⁻ⁿ(x,y,z)
where n is a number of SNRs multiplied.
Let x₋, x₀ and x₊ be grid nodes spaced by Δx.
Assume location function u₀=f(x₀,y₀,z₀) is bigger than u₋=f(x₋,y,z) and u₊=f(x₊,y,z), then δx to tune the event location in x is obtained by

$$δ x = \frac{{u}_{-} - {u}_{+}}{4 a Δ x} , a = \frac{{u}_{+} - 2 {u}_{0} + {u}_{-}}{2 Δ {x}^{2}} .$$

The tuned location is given by x₀+γx.
y and z are scanned in ranges such that |y₀−y|<pΔy and |z₀−z|<qΔz and points which have maximum values are selected
where Δy and Δz are grid spacing, and p and q are parameters.
D) Methods to compute the integration time interval for the probability density function and product of detection transforms, and the restriction on grid nodes. In some embodiments, the time interval of integration of 4-D (t,x,y,z) probability density function or product of detection transforms and the restriction of grid nodes are computed. Suppose a hypocenter is located at the grid node of (x, y, z), the start time can be computed as

$${T}_{Start} ( x , y , z ) = \frac{1}{N} {\sum }_{i = 1}^{N} ( {T}_{i} - {t}_{i} ( x , y , z ) )$$

where i is the index of data that indicates the receiver and a component of a signal (e.g., P- or Sh- or Sv-waves), T_{Start}(x,y,z) is the start time for (x,y,z); Tᵢ is the onset time; tᵢ(x,y,z) is the travel time between (x,y,z) to the receiver, and N is the number of data. If the uncertainties of onset times are known, the equation can be replaced by

$${T}_{Start} ( x , y , z ) = {\sum }_{i = 1}^{N} \frac{1}{{σ}_{i}^{2}} ( {T}_{i} - {t}_{i} ( x , y , z ) ) / {\sum }_{i = 1}^{N} \frac{1}{{σ}_{i}^{2}}$$

where σᵢ is the uncertainty of onset time of the i-th data. In the CMM case, σᵢ is taken as the length of a short time window in the detection transform.
The integration interval for (x,y,z) is taken as

|T_{Start}(x,y,z)−t|≦Cσᵢ

where t is the time and C is a parameter which is specifically taken between 2 to 4. The time integration and grid search is restricted for the grid nodes which satisfy

|T_{Start}(x,y,z)+tᵢ(x,y,z)−Tᵢ≦Cσᵢ

for all i.

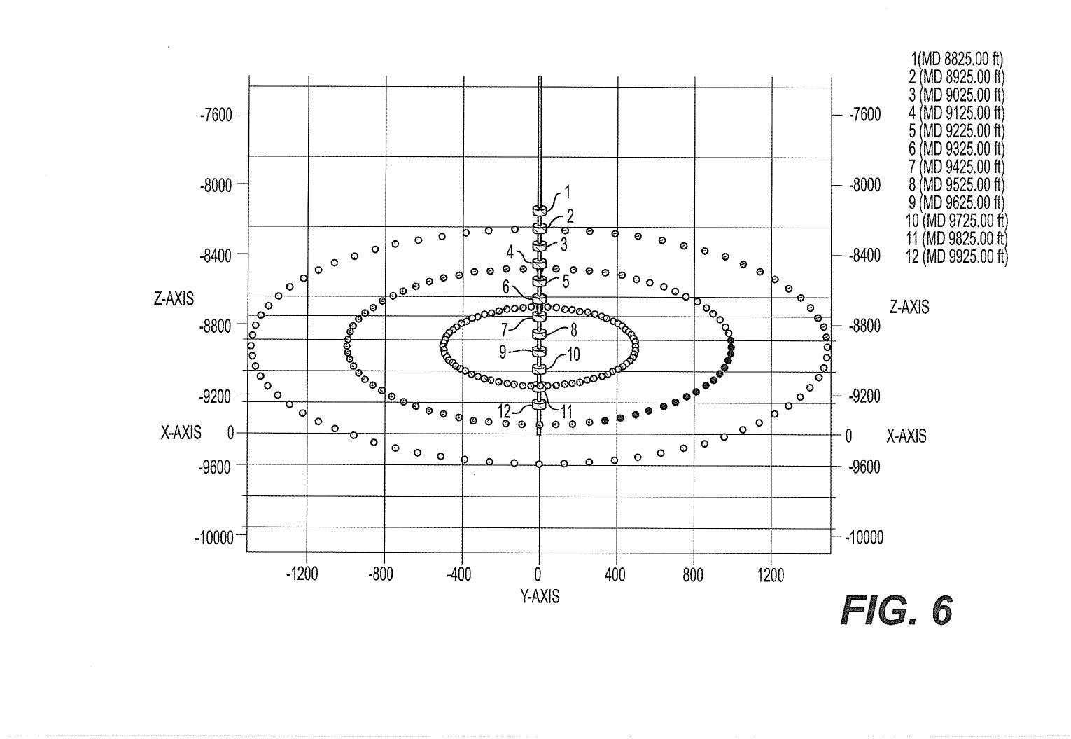

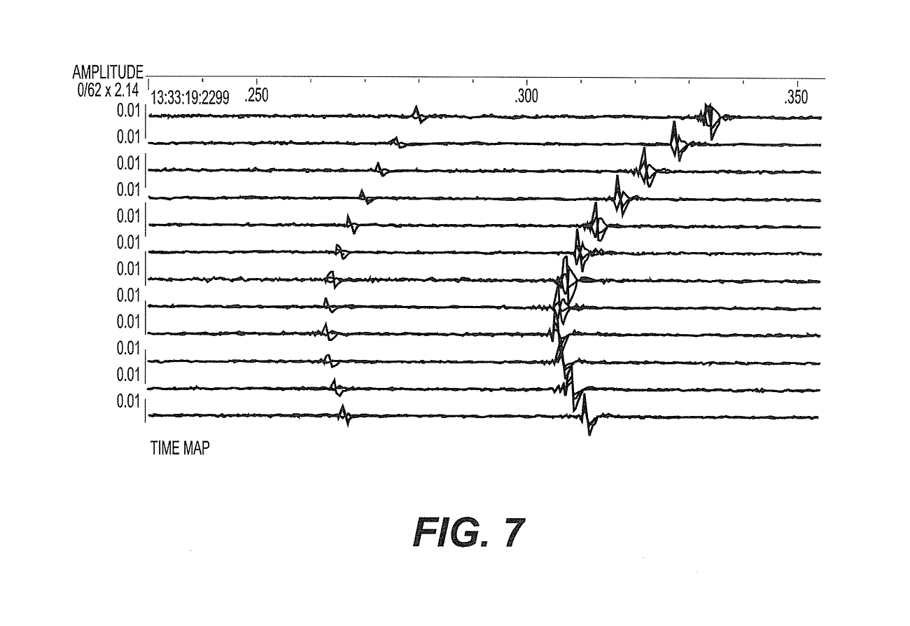

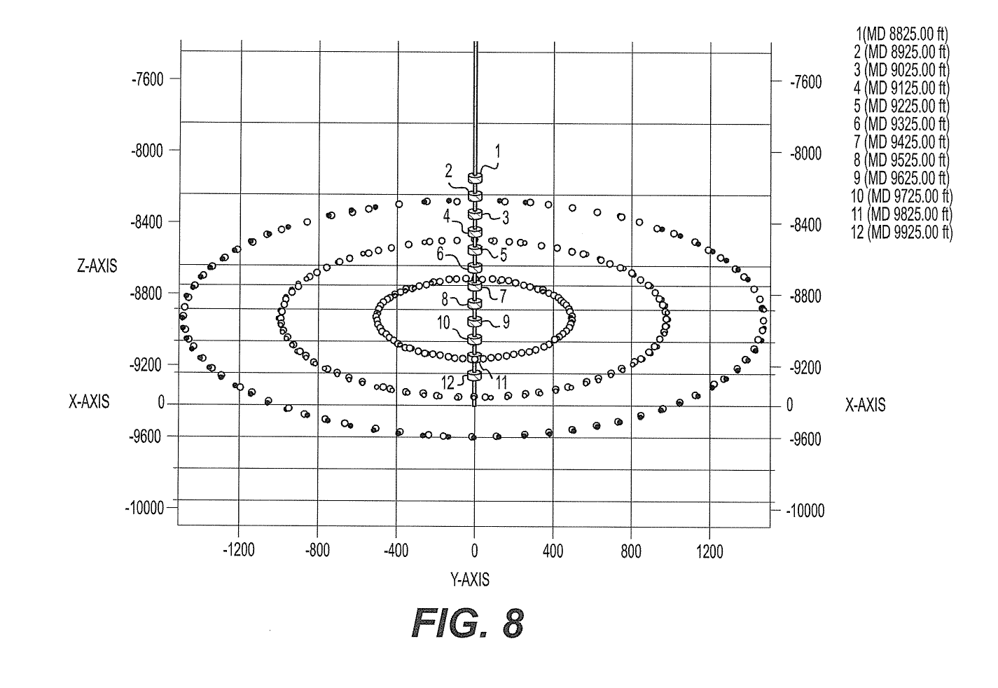

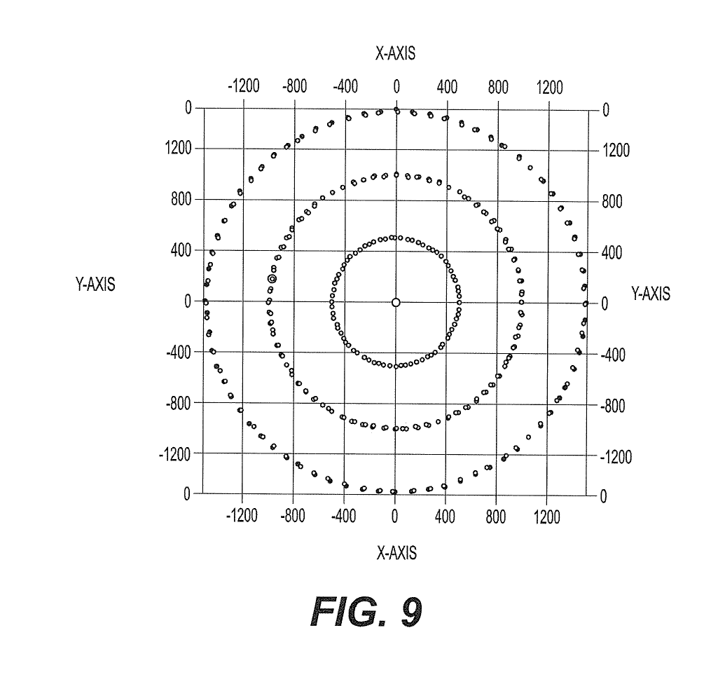

Example of Methods. FIG. 6 shows downhole receivers and hypocenter locations used in a synthetic test. Twelve receivers are installed in a vertical well and hypocenters are in three circles of 500, 1000 and 1500 ft away from the well. FIG. 7 shows an example of synthetic waveforms for the twelve receivers. The three component signals are overlaid on a single trace. The synthetic waveforms are generated by convolving a wavelet to travel times of P-, Sh- and Sv-waves that are computed using ray tracing. Amplitudes of signals of the three components are computed using ray vectors so that the polarization of signals are correct. The Gaussian noise whose standard deviation is 1% of maximum amplitudes is added to the waveforms. FIG. 4 shows the process flow that was used in the synthetic tests. FIG. 8 shows the hypocenters located using the process flow of FIG. 4. The hypocenters are located close to the exact positions and mostly they are overlaid. FIG. 9 shows the map view of hypocenter locations for the synthetic data. In the exemplified embodiment, the method improves the location accuracy and computational performance. By using the polarization PDF method, the azimuthal accuracy of hypocenter location is greatly improved. Without using the method, hypocenter locations are scattering in the azimuthal direction. The hypocenter locations are correctly located at the synthetic source locations without showing the scattering of locations around the synthetic sources that are observed in the location results using the non-modified detection transforms. Also, in the specific example, the grid increments of the look-up table are 40 feet and the results show the location accuracy is much better than 40 feet by using the interpolation method. In addition, as a single vertical well is used, the hypocenter locations can be flipped by 180 degrees centered in the well due to the 180 degree ambiguity of Hodogram. By using the described method of resolving 180 degree ambiguity, the hypocenters are correctly located without flipping.

Systems. The present disclosure also provides systems for improving the accuracy of detecting and/or locating a hypocenter for an event such as a microseismic event or an earthquake. The systems include one or more downhole receivers (such as part of a seismic array tool) for recording time and polarization information relating to a seismic event (such as an earthquake or a microseismic event), and a processor with machine-readable instructions for analyzing data according to one or more of A, B, C and/or D as follows:
A. comparing the recorded polarization for a picked onset time with a computed polarization stored in a look-up table to generate a difference in recorded and computed polarization for each receiver; computing a weighted average using the differences of measured and computed polarizations; and scanning the joint PDF of polarization PDF and onset time PDF to estimate the location, direction, or both of the event hypocenter;
B. computing the reference direction of polarization according to:

$${v}_{Ref} = {\sum }_{j \neq k} {c}_{2} Weight ( \frac{{p}^{j} + {c}_{1} {p}^{k}}{\vert {p}^{j} + {c}_{1} {p}^{k} \vert} )$$

where c₁=sgn(p^{j}·p^{k}),
c₂=−sgn((xₗ^{j}−xₗ^{k})(pₗ^{j}−pₗ^{k})),
l is the index which provides the maximum |xₗ^{j}−xₗ^{k}|,

$$Weight = \sqrt{max ( S N {R}_{j} - 1 , 0 ) max ( S N {R}_{k} - 1 , 0 ) {Linearity}_{j}^{q} {Linearity}_{k}^{q}}$$

where q is a power to be selected, and
the i-th receiver's position and polarization vector are denoted by
xⁱ=(x₁ⁱ,x₂ⁱ,x₃ⁱ) and pⁱ=(p₁ⁱ,p₂ⁱ,p₃ⁱ),
the sign of polarization vector is given by sgn(pⁱ·v_{Ref});
C. computing a probability density function (“PDF”) of event location; normalizing PDF according to f(x, y, z)=F⁻ⁿ(x, y, z); and tuning an event location according to:

$$δ x = \frac{{u}_{-} - {u}_{+}}{4 a Δ x} , \\ a = \frac{{u}_{+} - 2 {u}_{0} + {u}_{-}}{2 Δ {x}^{2}}$$

where the tuned location is given by x₀+γx, and
x₋, x₀ and x₊ are grid nodes spaced by Δx,
a location function u₀=f(x₀,y₀,z₀) is bigger than u₋=f(x₋,y,z) and u₊=f(x₊,y,z),
y and z are scanned in ranges such that |y₀−y|<pΔy and |z₀−z|<qΔz
and points which have maximum values are selected;
   and,
   D. computing the integration interval of time for the probability density function and product of the detection transforms and the restriction on grid nodes.
      For example, suppose a hypocenter is located at the grid node of (x,y,z), the start time can be computed as

$${T}_{Start} ( x , y , z ) = \frac{1}{N} {\sum }_{i = 1}^{N} ( {T}_{i} - {t}_{i} ( x , y , z ) )$$

where i is the index of data that indicates the receiver and component of signal (e.g., P- or Sh- or Sv-waves), T_{Start}(x,y,z) is the start time for (x,y,z); Tᵢ is the onset time; tᵢ(x,y,z) is the travel time between (x,y,z) to the receiver. N is the number of data. If the uncertainties of onset times are known, the equation can be replaced by

$${T}_{Start} ( x , y , z ) = {\sum }_{i = 1}^{N} \frac{1}{{σ}_{i}^{2}} ( {T}_{i} - {t}_{i} ( x , y , z ) ) / {\sum }_{i = 1}^{N} \frac{1}{{σ}_{i}^{2}}$$

where σᵢ is the uncertainty of onset time of the i-th data. In CMM case, σⁱ is taken as the length of a short time window in the detection transform. The integration interval for (x, y, z) is taken as

|T_{Start}(x,y,z)−t|≦Cσᵢ

where t is the time and C is a parameter which is specifically taken between 2 to 4. The time integration and grid search is restricted for the grid nodes which satisfy

|T_{Start}(x,y,z)+tᵢ(x,y,z)−Tᵢ|≦Cσᵢ

for all i.

In some embodiments, the systems include from one to eight receivers. In some embodiments, the systems include eight or more receivers. In some embodiments, the processor is configured to analyze data according to A above. In some embodiments, the processor is configured to analyze data according to B above. In some embodiments, the processor is configured to analyze data according to C above. In some embodiments, the processor is configured to analyze data according to D above. In some embodiments, the processor is configured to analyze data according to one or more of A, B, C and D according to the user's preference. For example, in some embodiments, the processor is configured to analyze data according to A and B, or according to A and C, or according to A and D, or according to B and C, or according to B and D, or according to A, B, and C, or according to A, B, and D, or according to B, C, and D, or according to A, B, C, and D.

A number of embodiments have been described. Nevertheless, it will be understood that various modifications may be made without departing from the spirit and scope of the present disclosure. Accordingly, other embodiments are included as part of the present disclosure and may be encompassed by the attached claims. Furthermore, the foregoing description of various embodiments does not necessarily imply exclusion. For example, “some” embodiments or “other” embodiments may include all or part of “some”, “other” and “further” embodiments within the scope of the present disclosure.

What is claimed is:

1. A method of detecting and locating a microseismic event, comprising:
a. measuring onset time and polarization data for a microseismic event using at least one downhole receiver;
b. computing an onset time probability density function (“PDF”) from measured onset time data;
c. computing a polarization PDF using a weighted average of differences between measured polarization data associated with measured onset time data and computed polarizations stored in a look-up table;
d. computing a joint PDF of polarization PDF and onset time PDF; and
e. scanning the joint PDF against the look-up table to estimate a location or direction or both of a hypocenter.

2. A method according to claim 1, wherein the onset time PDF is computed by an inverse method using a probability density function.

3. A method according to claim 1, wherein the onset time PDF is computed by Coalescence Microseismic Mapping using a modified detection transform.

4. A method according to claim 1, wherein the look-up table is prepared in 3-D space, where hypocenter locations are anticipated, as determined using only onset times.

5. A method according to claim 1, wherein the look-up table is generated by computing travel times and polarizations using at least one of ray tracing, Eikonal equation, or difference method for each candidate hypocenter location.

6. A method according to claim 1, wherein the weighted average of differences is defined by:
θ_{i,Error}(x,y,z)=|A cos(P_{i,mes}·P_{i,comp}(x,y,z))|

where i is an index of a receiver, θ_{i,Error} is a polarization error, P_{i,mes} and P_{i,comp}(x,y,z) are measured and computed polarization vectors at an i-th receiver for a hypocenter location at (x,y,z), and all vectors are normalized.

7. A method according to claim 6, wherein the polarization error is defined by:
$${θ}_{Error} ( x , y , z ) = {( \frac{{\sum }_{i = 1}^{N} {w}_{i} {θ}_{i , Error}^{n} ( x , y , z )}{{\sum }_{i = 1}^{N} {w}_{i}} )}^{- n}$$
where n is an appropriate power to be selected and wᵢ is a weight function of signal-to-noise ratio (“SNR”), linearity and orthogonality of an event signal denoted by:
wᵢ=f(SNRᵢ,Linearityᵢ,Orthogonalityᵢ)
where SNR is a value of a detection transform at an onset time.

8. A method according to claim 7, wherein:
wᵢ=SNRᵢ^{p}·Linearityᵢ^{q}·Orthogonalityᵢ^{r}
where p, q and r are appropriate powers to be selected.

9. A method according to claim 8, wherein SNR is replaced by
SNR′=max(SNR−1,0).

10. A method according to claim 6, further comprising denoting an (x′,y′,z′) that minimizes θ_{Error}(x,y,z), and using a probability density function where the polarization PDF is defined by
$$P D {F}_{Pol} ( x , y , z ) = {\prod }_{i} exp [ - \frac{1}{2} {( \frac{{θ}_{i , Error} ( x , y , z ) - {θ}_{i , Error} ( {x}^{′} , {y}^{′} , {z}^{′} )}{{σ}_{i}} )}^{2} ]$$
where
σᵢ=max(θ_{i,Error}(x′,y′,z′),θₘᵢₙ)
and
θₘᵢₙ is a pre-determined minimum angle.

11. A method according to claim 10, wherein a standard deviation is defined by:
$${σ}_{θ} = {( \frac{1}{N} {\sum }_{i} {σ}_{i}^{- 2} )}^{- 2} nearby ( {x}^{′} , {y}^{′} , {z}^{′} )$$
$$and$$
$${\vert \frac{{θ}_{Error} ( x , y , z ) - {θ}_{Error} ( {x}^{′} , {y}^{′} , {z}^{′} )}{{σ}_{θ}} \vert}^{2} \approx \frac{1}{N} {\sum }_{i} {( \frac{{θ}_{i , Error} ( x , y , z ) - {θ}_{i , Error} ( {x}^{′} , {y}^{′} , {z}^{′} )}{{σ}_{i}} )}^{2}$$
and the polarization PDF is defined by:
$$P D {F}_{Pol} ( x , y , z ) = exp [ - \frac{1}{2} {( \frac{{θ}_{Error} ( x , y , z ) - {θ}_{Error} ( {x}^{′} , {y}^{′} , {z}^{′} )}{{σ}_{θ}} )}^{2} ] .$$

12. A method according to claim 11, wherein the polarization PDF is defined by:
$$P D {F}_{Pol} ( x , y , z ) = exp [ - \frac{1}{2} {( \frac{{θ}_{Error} ( x , y , z )}{{σ}_{θ}} )}^{2} ] .$$

13. A system for estimating a location, direction, or both of a hypocenter, comprising:
a. at least one downhole receiver for recording time and polarization information relating to a microseismic event;
b. a processor for computing an onset time PDF using only onset times; computing a polarization PDF using a weighted average of differences between measured polarizations associated with onset times and computed polarizations stored in a look-up table; and computing a joint PDF of the polarization PDF and the onset time PDF; and
c. an electronics subsystem for scanning the joint PDF against the look-up table to estimate a location or direction or both of a hypocenter.

14. A method for detecting and locating a microseismic event, comprising:
a. receiving data relating to a microseismic event using at least two downhole receivers; and
b. estimating a location of a hypocenter by computing a time integral of a product of detection transforms associated with onset times from the received data using Coalescence Microsesimic Mapping,
wherein SNR is defined as: f_{d}(t)=max(ε, f_{d}(t)−1), and ε is a positive, small number.

15. A method according to claim 14, wherein ε is exp(−2).

16. A method for detecting a location of a microseismic event, comprising:
a. receiving polarization information relating to a microseismic event using at least two downhole receivers; and
b. computing the reference direction of polarization that provides the sign of measured polarization through inner product according to:
$${v}_{Ref} = {\sum }_{j \neq k} {c}_{2} Weight ( \frac{{p}^{j} + {c}_{1} {p}^{k}}{\vert {p}^{j} + {c}_{1} {p}^{k} \vert} )$$
where c₁=sgn(p^{j}·p^{k}),
c₂=−sgn((xₗ^{j}−xₗ^{k})(pₗ^{j}−pₗ^{k})),
l is the index which provides the maximum
Weight=\sqrt{(SNRⱼ−1)(SNRₖ−1)Linearityⱼ^{q}Linearityₖ^{q}}
where q is a power to be selected, and
the i-th receiver's position and polarization vector are denoted by
xⁱ=(x₁ⁱ,x₂ⁱx₃ⁱ) and pⁱ=(p₁ⁱ,p₂ⁱ,p₃ⁱ), and
the sign of polarization vector is given by sgn(pⁱ·v_{Ref}).

17. A method for improved detection of a location of a microseismic event, comprising:
a. receiving data relating to a microseismic event using at least two downhole receivers;
b. using the data to compute a polarization PDF and a joint PDF of polarization PDF and onset time PDF;
c. normalizing a product of a probability density function and the joint PDF according to: f(x, y, z)=F⁻ⁿ(x, y, z), wherein n is the number of data used;
d. tuning an event location according to:
$$δ x = \frac{{u}_{-} - {u}_{+}}{4 a Δ x} , \\ a = \frac{{u}_{+} - 2 {u}_{0} + {u}_{-}}{2 Δ {x}^{2}}$$
wherein the tuned location is given by x₀+δx, and
x₋, x₀ and x₊ are grid nodes spaced by Δx,
a location function u₀=f(x₀,y₀,z₀) is bigger than u₋=f(x₋,y,z) and u₊=f(x₊,y,z),
y and z are scanned in ranges such that |y₀−y|<pΔy and |z₀−z|<qΔz
and points which have maximum values are selected; and
e. computing an integration time interval for a 4-D (t,x,y,z) probability density function and a product of detection transforms and restriction on grid nodes for a hypocenter located at the grid node of (x,y,z).

18. A method according to claim 17, further comprising computing a start time:
$${T}_{Start} ( x , y , z ) = \frac{1}{N} {\sum }_{i = 1}^{N} ( {T}_{i} - {t}_{i} ( x , y , z ) )$$
where i is an index of data that indicates a receiver and component of signal,
T_{Start}(x,y,z) is a start time for (x,y,z), Tᵢ is an onset time, tᵢ(x,y,z) is a travel time between (x,y,z) to a receiver, N is the number of data; and,
an integration interval for (x,y,z) is taken as

|T_{Start}(x,y,z)−t|≦Cσᵢ
where t is time and C is a parameter ranging from 2 to 4, and time integration and grid search are restricted for grid nodes which satisfy

|T_{Start}(x,y,z)+tᵢ(x,y,z)−Tᵢ≦Cσᵢ
for all i.

19. A method according to claim 18, wherein onset times are known and T_{Start} is replaced by:
$${T}_{Start} ( x , y , z ) = {\sum }_{i = 1}^{N} \frac{1}{{σ}_{i}^{2}} ( {T}_{i} - {t}_{i} ( x , y , z ) ) / {\sum }_{i = 1}^{N} \frac{1}{{σ}_{i}^{2}}$$
where σᵢ is uncertainty of onset time of an i-th data, and when Coalescence Microsesimic Mapping is used, σᵢ is taken as a length of a short time window of a detection transform.
